(19) United States
(12) Patent Application Publication
(10) Pub. No.: US 2020/0225787 A1
(43) Pub. Date: Jul. 16, 2020

(54) STROKE-BASED OBJECT SELECTION FOR DIGITAL BOARD APPLICATIONS

(71) Applicant: Pathway Innovations and Technologies, Inc., San Diego, CA (US)

(72) Inventors: Ji Shen, San Diego, CA (US); FengGang Wu, San Diego, CA (US)

(21) Appl. No.: 16/831,799

(22) Filed: Mar. 26, 2020

Related U.S. Application Data
(63) Continuation of application No. 15/968,726, filed on May 1, 2018.
Application No. 15/968,726 is a continuation of application No. 16/816,156, filed on Mar. 11, 2020.
(60) Provisional application No. 62/824,296, filed on Mar. 26, 2019.
(60) Provisional application No. 62/824,293, filed on Mar. 26, 2019.
(60) Provisional application No. 62/492,867, filed on May 1, 2017.
(60) Provisional application No. 62/816,863, filed on Mar. 11, 2019.

(51) Int. Cl. G06F 3/044; G06F 3/045

(52) U.S. Cl. CPC G06F 3/044; G06F 3/045; G06F 2203/04102; G06F 2203/04107; G06F 2203/04104; G06F 2203/04106

(57) ABSTRACT

A dynamic digital board application that can detect words based on stroke recognition. In an exemplary embodiment of the digital board application using stroke-based word selection, the application comprises: a display; memory; one or more processors; one or more modules stored in the memory and configured for execution by the one or more processors, wherein the one or more modules includes instructions to detect a first contact on the display and create an object variable, to create a pointer identification, to save the object and push it into a cached objects array, to calculate a distance threshold between the pointer and a last object in cached objects array, wherein the digital board includes a graphical, interactive user-interface object with which a user interacts. A method of stroke-based word selection for a digital board application comprising the steps of: detecting a first contact on the display and creating an object variable; creating a pointer identification; saving the object and pushing it into a cached objects array; calculating a distance threshold between the pointer and a last object in cached objects array, wherein the digital board includes a graphical, interactive user-interface object, interacted with by a user.

### CROSS-REFERENCE TO RELATED APPLICATIONS

The present disclosure claims priority to U.S. Provisional Patent Application No. 62/824,296 filed on Mar. 26, 2019 and entitled, “Stroke-Based Object Selection for Digital Board Applications;” U.S. patent application Ser. No. 16/831,782 filed on Mar. 26, 2020 and entitled, “Gesture-Based Transitions Between Modes for Mixed Mode Digital Boards,” which claims priority to U.S. Provisional Patent Application No. 62/824,293 filed on Mar. 26, 2019 and entitled, “Gesture-Based Transitions Between Modes for Mixed Mode Digital Boards;” and U.S. patent application Ser. No. 15/968,726 filed on May 1, 2018 and entitled, “Capacitance and Conductivity Dual Sensing Stylus-Independent Multitouch Film,” which claims priority to U.S. Provisional Patent Application No. 62/492,867 filed on May 1, 2017 and entitled, “Capacitance and Conductivity Dual Sensing Stylus-Independent Multitouch Film;” and U.S. patent application Ser. No. 16/816,156 filed on Mar. 11, 2020 and entitled, “Capacitive Pressure Sensing for Paper and Multiple Writing Instruments,” which claims priority to U.S. Provisional Patent Application No. 62/816,863 filed on Mar. 11, 2019 and entitled, “Capacitance Sensing Apparatus for a Digital Writing Pad;” the entire disclosures of which are incorporated herein by reference.

### BACKGROUND OF THE INVENTION

### 1. Field of Invention

The invention relates to digital board user interfaces that employ touch-sensitive displays, and more specifically, to a technique for selection of digitally displayed objects.

### 2. Description of Related Art

Handwriting remains an indispensable tool for taking notes and jotting down ideas, for example for students in a classroom, professionals in a business meeting, scholars at a conference, or any person who wants to save written information. Over centuries, the most common instruments people have used to write are paper and various writing implements such as brushes, ink quills, pens, pencils, etc. In an era of digital information and distribution, it is desirable to record notes and drawings for the convenience of editing, sharing, and archiving. For this reason, many people use a computing device with an interactive whiteboard (also known as a digital board or smart board) software on a daily basis. Traditional digital board software is helpful for a number of applications including note taking, drawing, image manipulation, presentation creation, and so forth. In today's growing digitally prompted productivity, it is desirable to have a device with a touch-sensitive display that enables smart word selection to facilitate workflow and optimize time efficiency.

Most digital board software is used by manipulating a cursor on a computer. Currently, more and more people are using digital board software in conjunction with touch-sensitive displays. Touch-sensing screen technologies exist using a variety of methods such as: resistive, capacitive, surface acoustic wave, infrared, and pressure-sensitive liquid crystal display (LCD) technologies.

For example, digital touchpads are becoming increasingly accurate at recording a user's stroke and stroke patterns. A number of digital board software applications exist including, but not limited to, Microsoft Paint, Microsoft Ink, Photoshop, Smart Notebook, and Promethean ActiveInspire. Most of these digital board applications have a selection mode. In the selection mode, the user has the ability to select an object or a set of strokes representing objects. Once the object of interest is selected, the user can manipulate it. However, currently available digital board software requires a user to actively switch modes, for example, from selection mode to outline mode to isolate an exact object the user wishes to manipulate. In particular, with such software the user needs to identify and select a set of strokes belonging to an object, such as a sensible word. Digital board software and its implementation of object selection is limited by the need for a user's input, which limits digital board applications.

In light of these challenges in the field, there exists a need for a digital board application that automates grouping a set of strokes into an object to optimize time efficiency.

### SUMMARY OF THE INVENTION

The present invention overcomes these and other deficiencies of the prior art by providing a stroke-based word recognition for digital board applications. For example, the invention enables easy and efficient grouping of items based on the calculation of distances between strokes.

In an embodiment of the invention, a digital board system comprises a method comprising the steps of receiving information associated with a pointer down event, the pointer down event defined by a pointing device interacting with the touch-sensitive display; receiving information associated with a pointer up event, the pointer up event defined by the pointing device discontinuing interaction with the display; storing, to a computer-readable memory, a path object comprising information relating to the path of the pointing device as it interacts with the display; comparing the path object to a set of predefined objects; and in the event the path object matches a predefined object of the set of predefined objects, outputting, to the display, the matched predefined object of the set of predefined objects.

In another embodiment of the invention, a digital board system comprises a method comprising the steps of: receiving information associated with a first pointer down event, the first pointer down event defined by a pointing device interacting with the touch-sensitive display; receiving information associated with a first pointer up event, the first pointer up event defined by the pointing device discontinuing interaction with the display; storing, to a computer-readable memory, a first path object comprising information relating to the path of the pointing device as it interacts with the display between the first pointer down event and the first pointer up event; receiving information associated with a second pointer down event, the second pointer down event defined by the pointing device interacting with the touch-sensitive display; receiving information associated with a second pointer up event, the pointer up event defined by the pointing device discontinuing interaction with the display; storing, to the computer-readable memory, a second path object comprising information relating to the path of the pointing device as it interacts with the display between the second pointer down event and the second pointer up event; in the event the distance between the first path object and the second pointer down event is less than a predetermined threshold, comparing the first path object and the second path object together to a set of predefined objects; and in the event the distance between the first path object and the second pointer down event is greater than or equal to the predetermined threshold, comparing the first path object to the set of predefined objects.

In an embodiment of the invention, a digital board comprises: a display; memory; one or more processors; one or more modules stored in the memory and configured for execution by the one or more processors, the one or more modules including instructions: to detect a first contact on the display and create an object variable, to create a pointer identification, to save the object and push it into a cached objects array, to calculate a distance threshold between the pointer and a last object in cached objects array, wherein the digital board includes a graphical, interactive user-interface object with which a user interacts.

The advantages of the present invention include being a low-cost, efficient, and dynamic digital board application that can detect words based on stroke recognition.

The foregoing, and other features and advantages of the invention, will be apparent from the following, more particular description of the preferred embodiments of the invention, and the accompanying drawings.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIGS. 1A and 1B illustrates a digital whiteboard system converting a stroke-based object into a text-based object, according to an embodiment of the invention;

FIGS. 2A and 2B illustrates a digital whiteboard system converting a stroke-based object into a text-based object, according to an embodiment of the invention;

FIGS. 3A and 3B illustrates a digital whiteboard system converting a stroke-based object into a text-based object, according to an embodiment of the invention; and

FIG. 4 illustrates a user selecting a text based object displayed on a digital whiteboard system, according to an embodiment of the invention.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF PREFERRED EMBODIMENTS

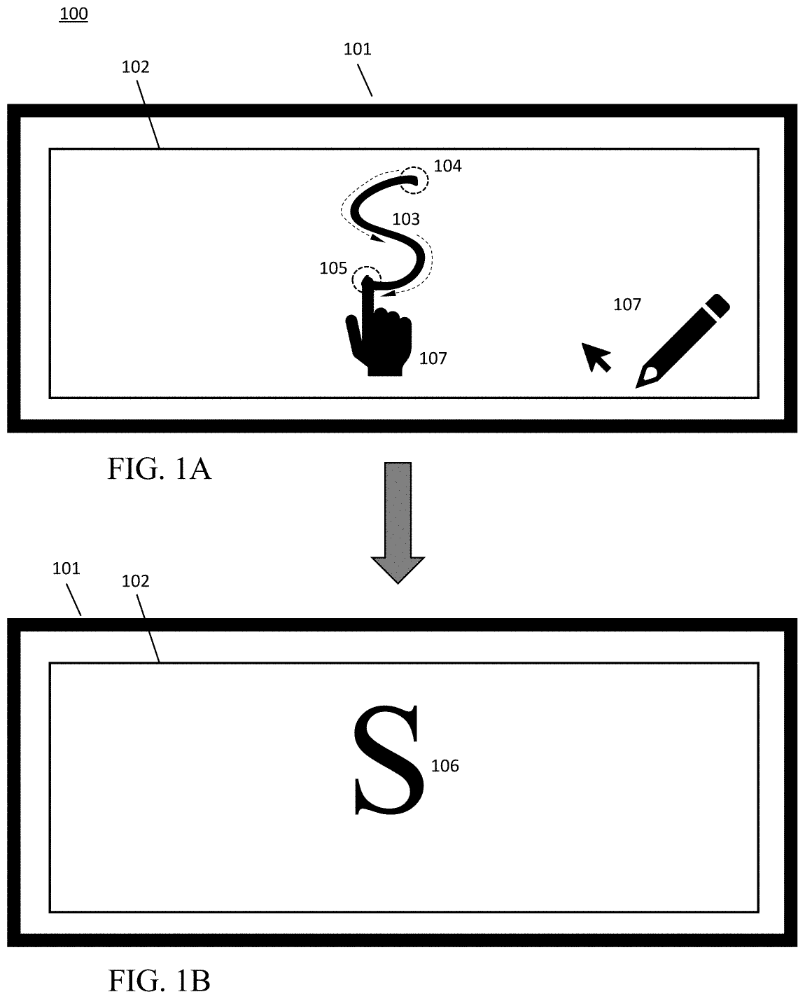

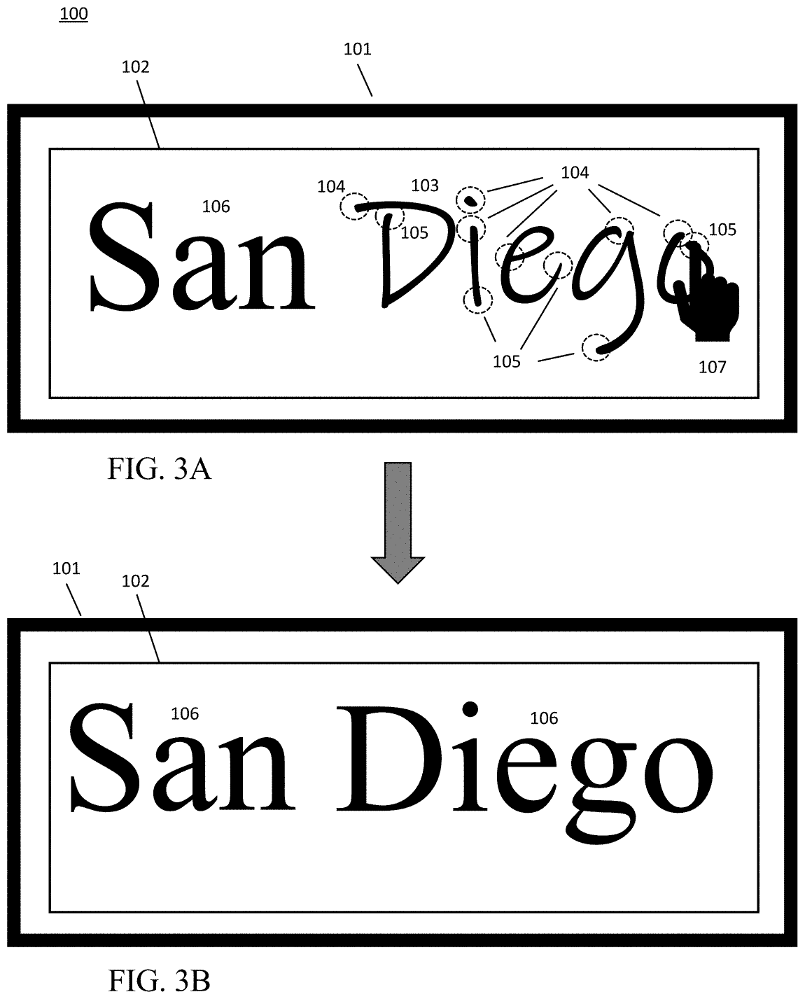

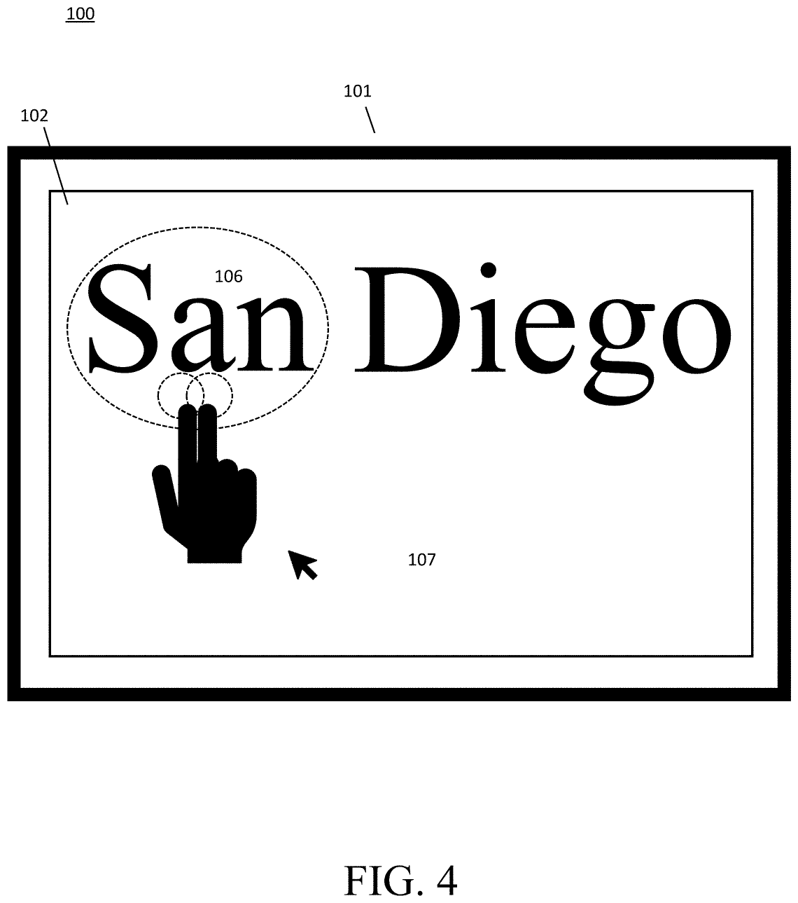

Preferred embodiments of the present invention and their advantages may be understood by referring to FIGS. 1-4. The described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

The present invention provides a digital board software solution for grouping a set of strokes in selection of an object. In an exemplary embodiment of the present invention, a user applies pressure to a touch-sensing device via a graphical user interface. The user is able to create and manipulate objects on the graphical user interface of the digital board software. The digital board software recognizes and groups letters into words.

The present invention comprises one or more displays. Such a display can be any type of display as would be apparent to one of ordinary skill in the art. Exemplary displays include electroluminescent (“ELD”) displays, liquid crystal display (“LCD”), light-emitting diode (“LED”) backlit LCD, thin-film transistor (“TFT”) LCD, light-emitting diode (“LED”) displays, OLED displays, AMOLED displays, plasma (“PDP”) display, and quantum dot (“QLED”) displays. Additionally, the displays can be standalone units such as televisions and/or computer monitors, or integrated into other devices such as cellular telephones and tablet computers. The one or more displays may further comprise touch-sensitive displays capable of interacting a user's finger and/or an electronic/digital pen.

According to an embodiment of the invention, a digital board system comprises a computer, a touch-sensing display as a data input/output, and digital board software executed by the computer. A digital board system can be a standalone system integrated together as a single device or a multicomponent system where the computer is separate from the display. A digital board system can be coupled to a computer network for data communications to other computers and even other digital board systems. A digital board system can also take the form of a mobile device such as a tablet, laptop, or smartphone. Digital board software utilizes discreet modes to facilitate object creation versus object manipulation. A user applying pressure to the touch-sensing display is able to interact with the digital board software. In the present invention, the user is able to easily switch between these different modes by using simple gestures.

The touch-sensing display comprises a touchscreen, the implementation and identification of which is apparent to one of ordinary skill in the art, and a display. Exemplary displays include electroluminescent (“ELD”) displays, liquid crystal display (“LCD”), light-emitting diode (“LED”) backlit LCD, thin-film transistor (“TFT”) LCD, light-emitting diode (“LED”) displays, OLED displays, AMOLED displays, plasma (“PDP”) display, and quantum dot (“QLED”) displays. The touchscreen is capable of sensing a user's finger or fingers, a stylus, and/or an electronic/digital pen.

The digital board software presents a digital canvas on the display. A digital canvas is the area on a display on which a user can draw, write, annotate, and/or manipulate objects, among other actions. The digital canvas may be presented in the entire portion of visible area of the display or in a portion thereof such as a display window. Additionally, multiple digital canvases can be presented on a single display. A single digital canvas can be presented on multiple displays in whole or in part. For example, a single digital canvas can be such that a portion thereof is presented on a first display and the remainder is presented on a second display, i.e., a single digital canvas is extended across two or more displays. Additionally, the digital canvas can be resized. In such embodiments, the digital canvas is resized by extending or collapsing a side or corner of the digital canvas display window, the implementation of which is apparent to one of ordinary skill in the art. The digital canvas can also be extended by, for example, the gesture-based methodologies and techniques described herein. The digital canvas can also be resized by scaling the perimeter such that the aspect ratio between the width and the height remain constant.

An object is a graphical representation of data stored on a computer and/or within the digital board system. For example, objects include, but are not limited to, alphanumeric characters, lines, shapes, and/or images displayed on the display. Objects also include pictures, sounds, and movies, or other multimedia elements or information. A user can manipulate an object on the display using various modes that are user-selectable depending on the user's gesture when inputting information into the display, exemplary methodologies of which are described herein.

The present invention implements a pointing device. A pointing device allows the user to draw, add, annotate, or otherwise manipulate objects presented on the display. Such pointing devices include, but are not limited to, a user's hand or finger, and/or a keyboard. Exemplary pointing devices include motion-tracking pointing devices such as a computer mouse, a trackball, a joystick, a pointing stick, and other devices that allow the user to interact with and manipulate objects using gesture recognition and pointing through the use of an accelerometer and/or optical sensing technology. Exemplary pointing devices also include, but are not limited to, position-tracking pointing devices such as a graphics tablet, a stylus, an electronic/digital pen, a touchpad, and a touchscreen. Exemplary pointing devices further include, but are not limited to, an isometric joystick. Certain user events are processed and/or recorded by the present invention. For example, a pointer down event refers an event at which the pointing device initially interacts with the display. For example, when a user is using his or her finger to draw on the display, the pointer down event refers to the time and/or location at which the user first touches his or her finger to the display. Similarly, a pointer up event refers to the time and/or location at which the user discontinues the pointing device's interaction with the display. Continuing in the previous example, the pointer up event refers to the time and/or location at which the user removes his or her finger from the display.

The pointer down and pointer up events are associated with various types of information. For example, these events are associated with a timestamp as determined by the computer or by an external source. The pointer events can also include positional information as to where the event occurred in the digital canvas. For example, the pointer event positional information can have associated X-Y cartesian coordinates pertaining to the event's two-dimensional location on the display, the digital canvas, or both. The pointer event positional information may also have associated pixel information pertaining to the pixel or pixels at which the event occurred. Such positional information may also include the relative distance between a pointer down event and a pointer up event. The pointer down and pointer up events may also include information relating to the pointing device's interaction with the display, for example, the amount of force/pressure the user exerted on the display and/or digital canvas while interacting with it. The pointer down and pointer up events may also include the speed, velocity, and/or acceleration information derived from the user's interaction with the digital canvas. For example, when a user uses his or her finger to draw a line on the digital canvas, the color of the line may vary depending on the speed, velocity, or acceleration of the pointer relative to the digital canvas and the width of the line may vary with the amount of pressure the user applies to the digital canvas. Additionally, the pointer up and pointer down event information may be gathered from the display, the digital canvas, the pointing device, or an external device. For example, a stylus comprising accelerometers gathers sufficient positional information to allow the digital board software to determine the location on the display and/or digital canvas where the pointing device is interacting. In another example, the pointer event information can be received from an external device. In such an example, a camera or other imaging device may be used to record the pointing device as it interacts with the display and/or digital canvas. The digital board software can then extrapolate the pointing device's event information from the imagery.

The pointer up and pointer down events are also used to determine whether the user has performed a “tap” on the display. For example, if the amount time between the pointer down event and the pointer up event is below a predetermined threshold, the software determines the user initiated a single-finger tap on the display. In such an example, if the pointer down and pointer up events transpired within, for example, 250 milliseconds, the software determines the user “tapped” the display and accordingly implements the interactive mode associated with a single-finger tap. Thresholds smaller or larger than 250 milliseconds may be used without departing from the contemplated embodiments. Further, the system may dynamically adjust such threshold values either on its own or in a user-configurable format. In another example, the digital board software may examine the distance between the pointer down and pointer up events and, if the distance is lower than a predetermined threshold, the software implements the selection mode. In such an example, if the distance between the pointer down and pointer up events is, for example, 2 pixels, the software implements the associated interactive mode. Further, the system may dynamically adjust such threshold values either on its own or in a user-configurable format.

The pointer up and pointer down events are also used to determine whether the user initiated a multipointer event. Such multipointer events include, but are not limited to, a two-finger tap and a three-finger tap. In determining whether the user initiated a two-finger tap, the digital board system detects a first pointer down event, a second pointer down event, a first pointer up event, and a second pointer up event. The software compares, for example, the time and/or distance between the first pointer down event and the second pointer down event. If the pointer down events occurred within a predetermined threshold of time relative to one another, for example 300 milliseconds, the software will determine the user initiated a two-finger tap. Thresholds smaller or larger than 300 milliseconds may be used without departing form the contemplated embodiments. The system may dynamically adjust such threshold values either on its own or in a user-configurable format. The software may also perform a similar comparison to the first pointer up event and the second pointer up event in determining whether a two-finger tap occurred. In some embodiments, the digital board software compares the distance between the first pointer down event and the second pointer down event to determine whether a two-finger tap has occurred. In such an embodiment, the software determines a two-finger tap has occurred when the distance between the first pointer down event and the second pointer down event is within a predetermined threshold, for example, ten pixels. The system may employ smaller or larger thresholds, which the system may dynamically adjust such threshold values either on its own or in a user-configurable format, without departing from the contemplated embodiments. Additionally, the software may also compare the pointer up events to the pointer down events. For example, the software may determine the average distance and/or time between the two pointer down events and compare it to the correlating averages of the pointer up events. Once the digital board software determines which, if any of the multipointer events has occurred, the software may then utilize that information to determine whether and to which mode it should transition, if at all.

FIG. 1 illustrates a digital board system 100 comprising a display 101, a digital canvas 102, an object 103 a pointer down event 104, a pointer up event 105, and a pointing device 107. When the system 100 detects a pointer down event 104, the system begins recording the path taken by the pointing device 107 as it traverses the surface of the display 101. The system 100 accomplishes this by recording, for example, the pixels of the display 101 that intersect with the pointing device's path. Once the system 100 detects a pointer up event 105, the system records the path as an object 103. The digital board software then stores the object 103 in, for example, a cached array.

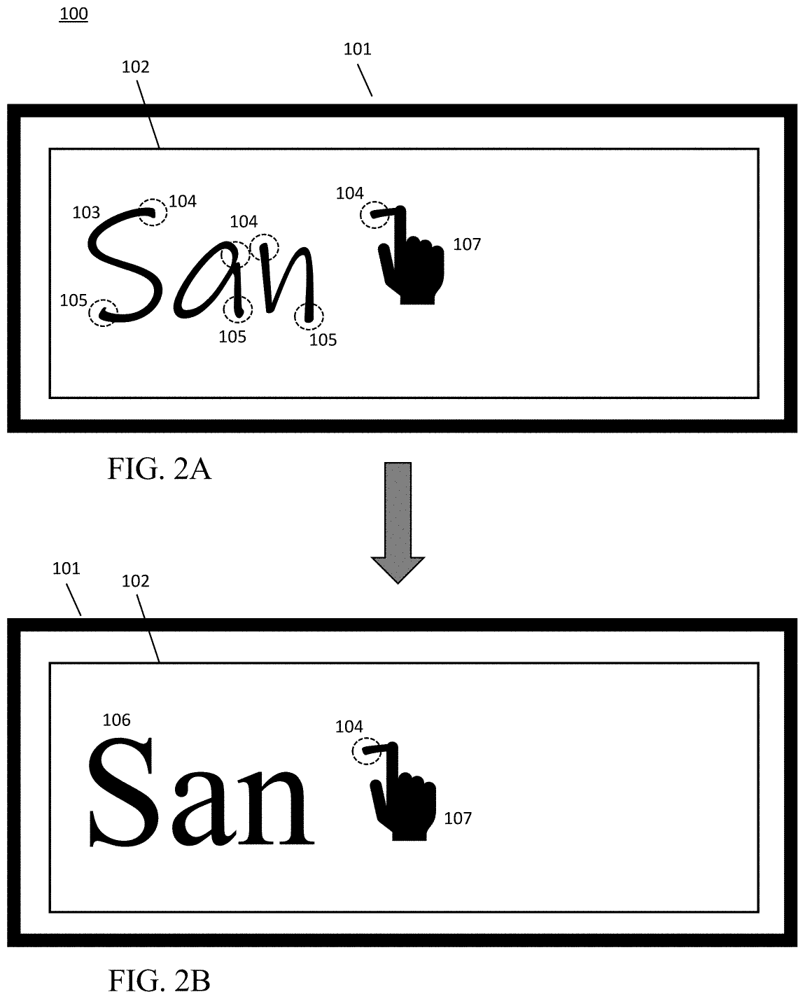

FIG. 2 illustrates a user using digital board software switching from a drawing mode to a selection mode. The selection mode is the second of the two modes described in FIG. 1. Selection mode allows the user to select objects, which have been drawn or inputted onto the digital canvas. The user is able to switch from drawing mode to selection mode with a gesture. For example a two-finger tap. A two-finger tap will immediately switch to selection mode and select the tapped object or objects. In selection mode the user is now able to manipulate the selected object or objects in any way allowed by the selection mode. The user is free to begin drawing at any time and the digital board will immediately switch back to drawing mode.

The digital board software is able to differentiate between different types of inputs using the time, and threshold of the user's pressure on the touch-sensing surface. For example, a pointer down event is when the user applies pressure to the touch sensing surface and a pointer up event is when a user removes pressure from the touch-sensing surface. Each pointer down event is given a unique identifier called pointer identification. With each pointer down event, the system generates a pointer identification associated with the pointing device and the pointer down event. After the pointer down event, as the pointer is moved across the surface of the touch sensing surface, a path object is generated. Each path event is assigned pointer identifications associated with the pointing device. When a pointer up event ends the path event, the collection of points result in a path object on the digital canvas. The digital board software assigns the path object a pointer identification associated with the pointing device. The path object's pointer identification may be the same as the pointing device's identification of the points that make up the object. The digital board software then stores the object and its corresponding information into memory and a cached object array.

Every time a subsequent pointer down event occurs the digital board software calculates the distance between the new pointer down event and the previous object in the cached object array if one exists. The new pointer down event is compared to the point of the previous object, which is closest to the new pointer down event. If the distance is larger than a predetermined distance the new object is considered separately from the previously cached object. In addition, the previously cached object is replaced with the new object. If the distance is shorter than a predetermined distance, the new object will be associated with the previous object and will be stored in the cached objects array with the previous object.

In FIG. 2, similarly as in FIG. 1, the outer square represents a display, the inner square represents a digital canvas, “San Diego” represents two objects in this example (i.e., two words) and the two circles represent a first and second contact, respectively (e.g., two finger tap for), and the larger circle represents an object that has been selected. For example, the letters S, A, and N would be associated as one word. The first object had been drawn as the letter S. The letter S will be saved into memory as well as the cached object array. Once the pointer down event for the A began, the digital board software determines if the distance between the pointer down event of the A and the closest point of the S were less than the predetermined distance. If the distance is less, than the new object will be associated with the S. If the distance is less the letter A will also be stored in the cached object array. This process would repeat for the letter N. Once the pointer down event occurs for the letter D, the digital board software will again compare the pointer down event for the letter D against the closest point of the letter N. Because the distance is larger than the predetermined distance the D will not be grouped with the letters S, A, or N. The letters S, A, and N, will no longer be stored in the cached object array. The letter D will be stored in the memory and the cached objects array and will be compared to subsequent pointer down events. Although in this example one of the main components for grouping objects is the distance between the objects other such methods may be used. The digital board software may use a framework of machine leaning algorithms to efficiently recognize letter and word groupings.

The digital board software registers a single tap when the digital board registers a pointer down event and a pointer up event at almost the same position in a very short time. Whenever there is a pointer down event, the digital board software records a system time down. When the pointer up event occurs the digital board software records a system time up. If the time duration between system time down and system time up is longer than a predetermined time limit, the digital board software does not consider the input a tap. In various examples, a default time duration is approximately 250 milliseconds, but a value smaller than or larger than 250 milliseconds may be used.

The threshold is the distance between a pointer down event and a pointer up event. When the pointer down event occurs the digital board software records a position down value. When the pointer up event occurs the digital board software records a position up value. If the distance between the position down value and position up value is longer than the predetermined threshold limit, the digital board software does not consider the input a tap. In this embodiment the threshold is approximately 2 pixels, but values smaller than 2 pixels, and values larger than 2 pixels may be used.

The interval is the time duration between the first pressure down event and the second pressure down event. When the digital board software receives two individual pressure down events, this could be a two-finger tap. If the time duration between the first pressure down event and the second pressure down event is longer than the predetermined interval limit, the digital board software does not consider the input a two-figure tap. In this embodiment the default interval to determine a two-finger tap is approximately 300 milliseconds, but a value smaller than 300 milliseconds, and a value larger than 300 milliseconds may be used.

When determining if a two-finger tap occurred the digital board software also considers the two-finger threshold. The two-finger threshold is the distance between two separate pressure down events. If the distance between the first pressure down event and the second pressure down event is larger than the predetermined two-finger threshold limit the digital board software will not consider the input a two-finger tap. In this embodiment the default threshold for a two-finger limit is approximately 10 pixels, but a value smaller than 10 pixels, and a value larger than 10 pixels may be used.

After the digital board software determines there is a two-finger tap, it determines the center of the two-finger tap. The center of the two-finger tap is the center of the distance between the first position down value and the second position down value. Once the center of the two-finger tap is found the digital board software goes through all the objects on the digital canvas and checks the objects' bounds. If the center of the two-finger tap is inside an object's bound, the digital board software will select the object.

In another embodiment, the digital board software has three modes, a digital canvas, and a cursor. The first two modes are drawing mode and selection mode as previously described. The third mode is lasso mode. Lasso mode allows the user to select a section of the canvas rather than a single object. The user may switch from drawing mode to lasso mode with a gesture. For example, a two finger tap. However, any similar gesture may be used as is readily apparent to one of ordinary skill in the art. If the digital board software determines the center of the two-finger tap is not in any object's bounds then it will immediately change from drawing mode to lasso mode.

In lasso mode, a user is able to lasso a section of the digital canvas by tracing a section with the cursor. The section of the digital canvas that is enclosed or partially enclosed by the tracing cursor will be selected. The digital board software will go through all the objects on the digital canvas to determine if any objects' bounds intersect with the traced lasso line. Any object with a bound that intersect the traced lasso line will be selected. The digital board software than immediately changes to selection mode. The user is now able to manipulate the selected objects in any way allowed by the selection mode. The user is free to begin drawing at any time and the digital board will immediately switch back to drawing mode.

In another embodiment the digital board software has a drawing mode, reformatting mode, digital canvas, and cursor. The digital board software is on a tablet computer. The user may wish to expand the window size of the digital canvas in real time while drawing. The user can use a gesture to cause the invention to enter reformatting mode and increases the available drawing area. For example, the gesture may be drawing within a predetermined distance from the edge of the digital canvas. However, any similar gesture may be used as is readily apparent to one of ordinary skill in the art. If the user draws within the predetermined distance from the edge of the digital canvas, the digital board software will automatically resize the drawing areas. The user is not required to click reformatting mode. The user can continue to draw seamlessly and use gestures to cause the digital canvas to resize.

As the user draws in drawing mode the digital board software registers each position up value. The digital board software determines the distance between the position up value and the edge of the digital canvas. If the distance between the position up value and the edge of the digital canvas is smaller than a predetermined edge threshold, the digital board software enters resizing mode and resizes the digital canvas. The distance and scaling of the edge threshold can be different based on the screen size or different drawing behaviors.

In resizing mode, if the digital board software determines that there is some distance between the digital canvas boundary and the tablet computer boundary, the digital canvas will increase to a larger width. The digital board software increases the width based on where the position up value is located.

In another embodiment, in resizing mode, the digital board software increases the width and the height based on the location of the position up value.

It may not always be possible for the digital canvas to expand its boundaries. If this is the case, the digital board software may scale the canvas down. When this happens all the objects on the canvas get smaller. When the canvas scales down, the digital board software will reduce the height and/or width, of the objects on the canvas. This will give the user more room to draw. The digital board software has a predetermined limitation value for how much the digital canvas can scale down. The predetermined limitation value relates to the minimum size of the objects on the digital canvas compared to their original size. In various examples, a default limitation value is approximately half the original size, a value smaller than or larger than half the original size.

The digital canvas may reach the scale down limitation value. When the scale down limitation is reached the digital board software moves objects on the canvas to allow for more space. For example, if the user has been using the right side of the digital canvas, the digital board software will move all the objects to the left. Some of the objects will be out of the digital canvas boundary and the digital board software will store the objects in the software's memory.

A user's strokes and stroke patterns may train a neural network and/or implement machine learning techniques to identify a complex object, such as word, to improve the accuracy of smart selection of objects.

The invention has been described herein using specific embodiments for illustrative purposes only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following drawings.

We claim:

1. A method comprising the steps of:
receiving information associated with a pointer down event, the pointer down event defined by a pointing device interacting with the touch-sensitive display;
receiving information associated with a pointer up event, the pointer up event defined by the pointing device discontinuing interaction with the display;
storing, to a computer-readable memory, a path object comprising information relating to the path of the pointing device as it interacts with the display;
comparing the path object to a set of predefined objects; and
in the event the path object matches a predefined object of the set of predefined objects, outputting, to the display, the matched predefined object of the set of predefined objects.

2. A method comprising the steps of:
receiving information associated with a first pointer down event, the first pointer down event defined by a pointing device interacting with the touch-sensitive display;
receiving information associated with a first pointer up event, the first pointer up event defined by the pointing device discontinuing interaction with the display;
storing, to a computer-readable memory, a first path object comprising information relating to the path of the pointing device as it interacts with the display between the first pointer down event and the first pointer up event;
receiving information associated with a second pointer down event, the second pointer down event defined by the pointing device interacting with the touch-sensitive display;
receiving information associated with a second pointer up event, the pointer up event defined by the pointing device discontinuing interaction with the display;
storing, to the computer-readable memory, a second path object comprising information relating to the path of the pointing device as it interacts with the display between the second pointer down event and the second pointer up event;
in the event the distance between the first path object and the second pointer down event is less than a predetermined threshold, comparing the first path object and the second path object together to a set of predefined objects; and
in the event the distance between the first path object and the second pointer down event is greater than or equal to the predetermined threshold, comparing the first path object to the set of predefined objects.
